(19) United States
(12) Patent Application Publication
(10) Pub. No.: US 2026/0036471 A1
(43) Pub. Date: Feb. 5, 2026

(54) WIRELESS TEMPERATURE MEASUREMENT SYSTEM

(71) Applicant: Combustion, LLC, Seattle, WA (US)

(72) Inventors: Christopher YOUNG, Seattle, WA (US); Jed MCCANN, Portland, OR (US); Josh BUESSELER, Seattle, WA (US)

(21) Appl. No.: 19/284,085

(22) Filed: Jul. 29, 2025

Related U.S. Application Data
(60) Provisional application No. 63/677,291, filed on Jul. 30, 2024.

(51) Int. Cl. G01K 1/14; G01K 1/024; G01K 1/12

(52) U.S. Cl. CPC G01K 1/14; G01K 1/024; G01K 1/12; G01K 2207/06

(57) ABSTRACT

A temperature measurement system includes a multi-layered heat shield assembly, a display removably coupleable to the heat shield, and a temperature sensor extending through the heat shield. The measurement system is configured to be mounted to a high-temperature cooking appliance with the temperature sensor detecting a temperature of an internal cavity of the appliance. The display includes a controller configured to collect data from the temperature sensor and wirelessly transmit the data to an external device or network. The multi-layered heat shield assembly is configured to maintain a temperature differential between the appliance and the display of up to 300 degrees C. to protect the electronics of the display.

### BACKGROUND

### Technical Field

The present disclosure generally relates to temperature measurement systems, methods, and devices that are particularly well suited for high temperature applications.

### Description of the Related Art

There are a variety of devices for measuring temperature. For example, meat thermometers can be inserted into a food product to measure an internal temperature of the food product. Other examples include temperature or heat gauges that measure the internal temperature of a cooking device or appliance, such as an oven, barbecue, and others. There are a number of deficiencies and disadvantages associated with such devices, and particularly for temperature or heat gauges that measure an internal temperature of barbecues, smokers, and other cooking high-temperature cooking appliances.

High-temperature cooking appliances, such as barbecues, smokers, and other like devices are often operated outdoors. As a result, the heat gauges associated with such devices are susceptible to damage over time from rain, snow, rust, and the like that can significantly impact their durability and expected lifespan before a replacement is needed. Such gauges are often constructed of cheap, low-grade components that do not accurately reflect the temperature inside the appliance. Still further, many gauges for high-temperature appliances are manual gauges, meaning that the temperature probe or sensor is associated with a dial which the user must read to obtain the temperature. In order to monitor the temperature over time, such as during a longer cook, the user must repeatedly return to the appliance to ensure the temperature remains appropriate for the cooking application. Wireless and electronic temperature gauges are typically not preferred for high-temperature applications or appliances because the heat from the appliance can cause damage to the internal electronics. Other prior electronic solutions do not sufficiently reject heat from the appliance to provide for reliable and accurate temperature measuring and durability over time. In addition, many barbecues and other like devices act as quasi-faraday cage devices that block transmission of signals such that wireless probes inside of these appliances are ineffective at wireless communication. There are many other deficiencies and disadvantages as well.

Accordingly, it would be beneficial to have temperature measurement systems, methods, and devices, and particularly, but not exclusively, for high-temperature applications, that overcome the deficiencies and disadvantages of current technology.

### BRIEF SUMMARY

The present disclosure is generally directed to temperature measurement systems, methods, and devices that are particularly well-suited for high-temperature applications and appliances.

As will be further described below, the present disclosure provides for an advanced digital, wireless temperature measurement system (“TMS”) designed to aid in temperature monitoring of grills, smokers, and other high-temperature appliances. The system may be an assembly including a heat shield sub-assembly, a removable digital display unit or display sub-assembly, and a precision temperature sensor operatively coupled together. The temperature sensor may extend through the heat shield and may detect temperature in an internal cavity of the appliance. The temperature measurement system according to the disclosure may provide several advantages, including heat rejection to protect the system and internal electronics over time, a high-grade temperature probe for accurate temperature readings, and wireless communication capability to enable remote monitoring.

In some embodiments, the TMS may include a mounting assembly configured to couple the heat shield sub-assembly to an outer shell of the appliance.

In some embodiments, the heat shield sub-assembly may include a base, a thermal insulation layer disposed on the base, at least one magnetic element, and a cover. The base may include at least three support legs. The cover may include a plurality of protrusions.

In some embodiments, the display may include a controller capable of wireless communication via at least one of Wi-Fi, long range (LoRa), Bluetooth Low Energy (BLE), or another radio communication protocol for remote monitoring and control of the TMS.

The present disclosure further relates to a method for measuring and displaying temperature of an internal cavity of an appliance, which may include mounting a multi-layered heat shield to an external surface of the appliance using an adjustable threaded assembly, inserting a temperature sensor through the heat shield into the internal cavity, magnetically attaching a display to the heat shield, and wirelessly transmitting temperature data from the display. Magnetically attaching the display to the heat shield may include establishing an electrical connection between the temperature sensor and the display via spring-loaded pins and concentric and thermally isolated conductive rings.

In some embodiments, a target temperature may be input to the display and transmitted to an external smart cooking device configured to control a temperature of the internal cavity of the appliance. A set temperature may be inputted to the display and communicated from the display to a combustion device configured to adjust a temperature in the internal cavity of the appliance.

In some embodiments, wirelessly transmitting temperature data from the display may include the display receiving power from a multi-stage battery. The multi-stage battery may include a first battery stage configured to recharge a second battery stage of the multi-stage battery. The second battery stage may be spaced apart from the appliance such that the first battery stage is closer to the appliance than the second battery stage.

The above summary is non-limiting, and additional embodiments and advantages of the disclosure are described in the following detailed description.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive embodiments are described with reference to the following drawings, wherein like labels refer to like parts throughout the various views unless otherwise specified. The sizes and relative positions of elements in the drawings are not necessarily drawn to scale in some figures. For example, the shapes of various elements are selected, enlarged, and positioned to improve drawing legibility. In other figures, the sizes and relative positions of elements in the drawings are exactly to scale. The particular shapes of the elements as drawn may have been selected for ease of recognition in the drawings. The figures do not describe every aspect of the teachings disclosed herein and do not limit the scope of the claims.

FIG. 1 is a perspective view of an embodiment of a TMS according to the present disclosure.

FIG. 2 is a top view of the TMS of FIG. 1 installed on a high-temperature appliance.

FIG. 3 is a side view of the TMS of FIG. 1 installed on a high-temperature appliance.

FIG. 4 is a cross-sectional view of the TMS of FIG. 1 along line A-A in FIG. 1 when installed on a high-temperature appliance.

FIG. 5 is an exploded view of the TMS of FIG. 1 showing sub-assemblies of the TMS.

FIGS. 6A-6C are exploded views of a display sub-assembly of the TMS of FIG. 1.

FIGS. 7A-7B are exploded views of a heat shield sub-assembly of the TMS of FIG. 1.

FIG. 8 is an exploded view of a temperature sensor sub-assembly of the TMS of FIG. 1.

FIG. 9 is a perspective view of another embodiment of a TMS according to the present disclosure.

FIG. 10 is a cross-sectional view of the TMS of FIG. 9 along line B-B in FIG. 9 when installed on a high-temperature appliance.

### DETAILED DESCRIPTION

Persons of ordinary skill in the relevant art will understand that the present disclosure is illustrative only and not in any way limiting. Other embodiments of the presently disclosed systems and methods readily suggest themselves to such skilled persons having the assistance of this disclosure.

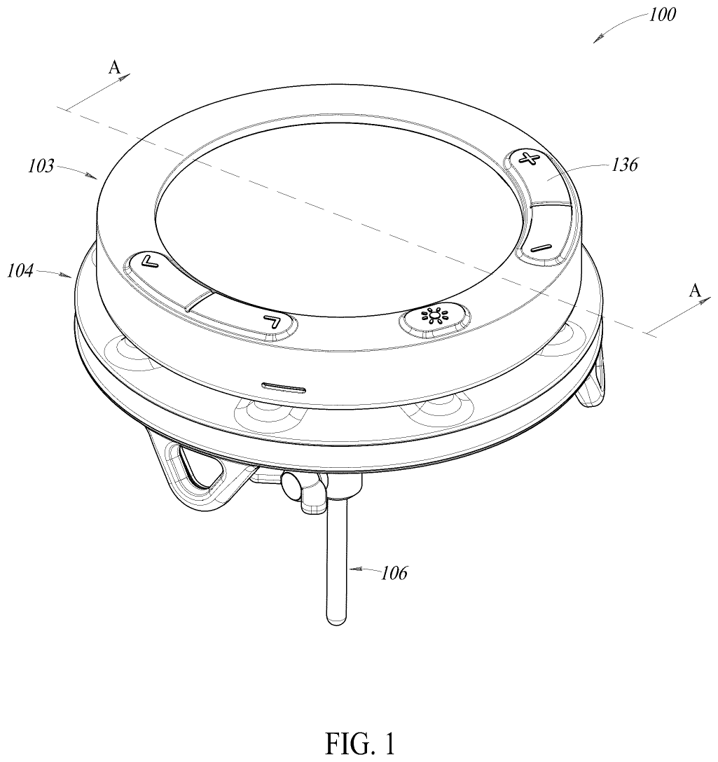

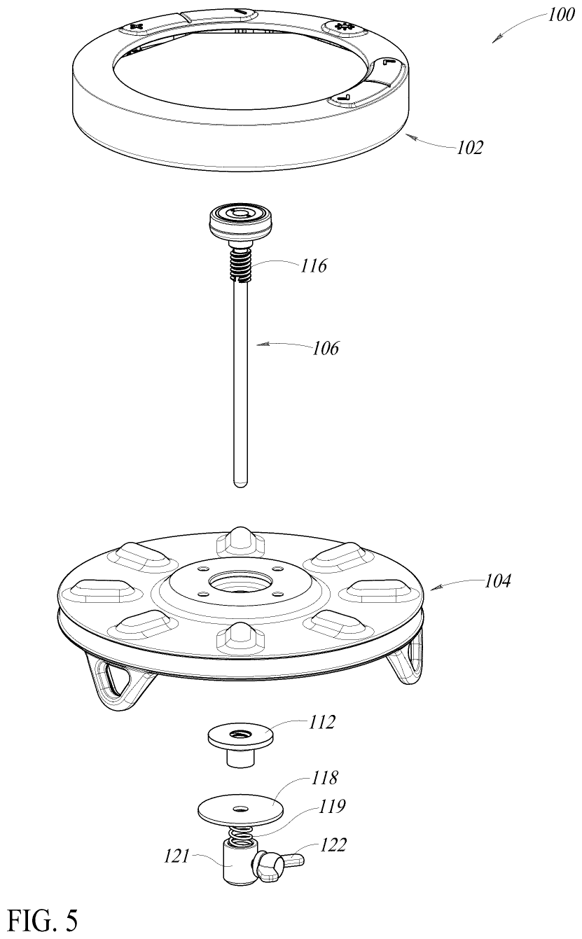

Each of the features and teachings disclosed herein can be utilized separately or in conjunction with other features and teachings to provide temperature measurement devices, systems, and methods. Representative examples utilizing many of these additional features and teachings, both separately and in combination, are described in further detail with reference to attached FIGS. 1-10. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter.

Except as otherwise mentioned herein, a “high-temperature” application or appliance is one where the cooking temperature is expected to exceed 500 degrees Fahrenheit (F) and in some cases, may exceed 700 or 800 degrees F. “High-temperature” applications or appliances therefore include, but are not limited to, barbecues, smokers, broilers, ovens, pizza ovens, and other like devices.

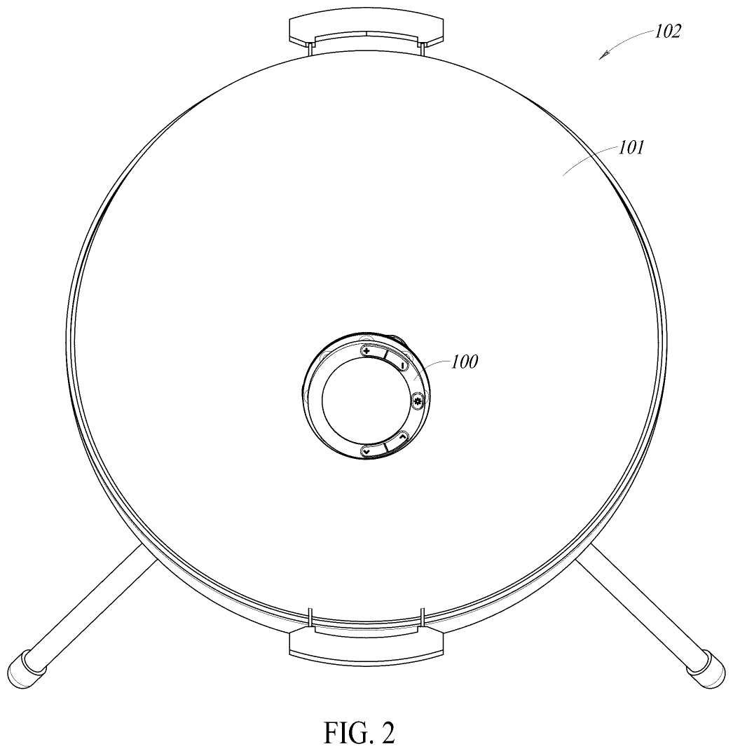

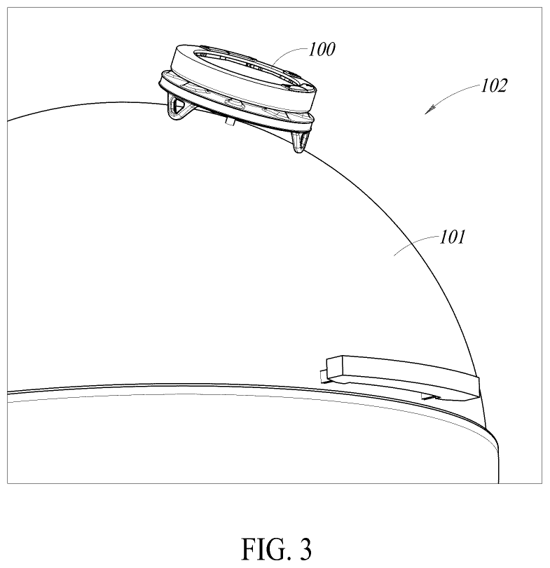

Beginning with FIG. 1, illustrated therein is an embodiment of a TMS 100 according to the present disclosure. FIGS. 2 and 3 show the TMS 100 when installed in an outer wall 101 of a high-temperature appliance 102. As shown in FIGS. 1-5, the TMS 100 includes a display sub-assembly 103 or controller sub-assembly 103 (which may also be referred to as a display 103 or a controller 103), a heat shield sub-assembly 104 (which may also be referred to as a heat shield 104), and a temperature sensor sub-assembly 106 (which may also be referred to as a temperature sensor 106).

As shown in FIGS. 1, 4, and 5, the temperature sensor 106 is received through a through-hole or aperture in the center of the heat shield 104 and generally extends downward away from the heat shield 104. The temperature sensor 106 includes a plug 108 that is received in a central cavity 110 in the heat shield 104 to prevent the plug 108 and the temperature sensor 106 from pulling through the heat shield 104. The plug 108 may be coupled to the heat shield 104 in a friction fit, force fit, snap fit, or other mechanical coupling methods. Further, the plug 108 may be attached to the heat shield 104 with adhesive, fasteners, and the like. Where adhesive is used, the adhesive may be high-temperature silicone adhesive.

In some embodiments, the heat shield 104 includes a rivet or weld nut 112 coupled to and extending from a bottom plate 114 of the heat shield 104. In some embodiments, the weld nut 112 may be welded to the bottom plate 114 of the heat shield 104. The weld nut 112 defines, in part, an axial bore 115 through which the temperature sensor 106 is inserted. The axial bore 115 may be threaded. An externally-threaded standoff 116, which likewise includes an axial bore 117 for receiving the temperature sensor 106 is inserted into the weld nut 112. The standoff 116 is configured to be threaded into the weld nut 112, such that the standoff 116 is present in the axial bore 115 defined by the weld nut 112.

In use, the temperature sensor 106 is inserted through a hole in the outer shell 101 of the high-temperature appliance 103. Then, a washer 118 may be guided along the temperature sensor 106, such that the washer 118 may be positioned adjacent to the outer shell 101 of the high-temperature appliance 102, opposite the weld nut 112 and/or the standoff 116. Next, a spring 119, for example, a helical spring, may be slid over the temperature sensor 106 adjacent to the washer 118, such that the spring 119 is configured to impart a force in a dimension D1 perpendicular to a planar face 120 of the washer 118. A collar 121 may then be slid over the temperature sensor 106, which may be configured to be positioned along the temperature sensor 106 by way of a set screw 122. For example, the set screw 122 may be a wing screw that enables simple tightening thereof to position the collar 121. The collar 121 may be positioned to compress the washer 118 against the outer shell of the high-temperature appliance, such that the outer shell of the high-temperature appliance is positioned between the washer 118 and the weld nut 112 and/or the standoff 116. Such a positioning of the collar 121 distributes force into the bottom plate 114 of the heat shield 104, by way of the washer 118, to establish a secure connection between the temperature sensor 106, the heat shield 104, and the high-temperature appliance.

In other embodiments, a wing nut may be guided onto the temperature sensor 106 and then coupled to the threaded standoff 116 and tightened against the outer shell of the high-temperature appliance such that the temperature sensor 106 is inside an internal cavity of the appliance. Tightening the wing nut distributes force into the bottom plate 114 of the heat shield 104 to establish a secure connection between the temperature sensor 106, the heat shield 104, and the high-temperature appliance.

The heat shield 104 may be removably or permanently coupled to the display 103 through the use of mechanical methods and devices, fasteners, adhesive, and the like. In some embodiments, the display 103 includes magnets 123 that establish a secure, but removable connection between the display 103 and metal material and magnetic material of the heat shield 104. It is preferable, but not required, that the display 103 be removably coupled to the heat shield 104 to enable maintenance on the display 103, such as to change batteries that power to the display 103. Each of the sub-assemblies are described in further detail below.

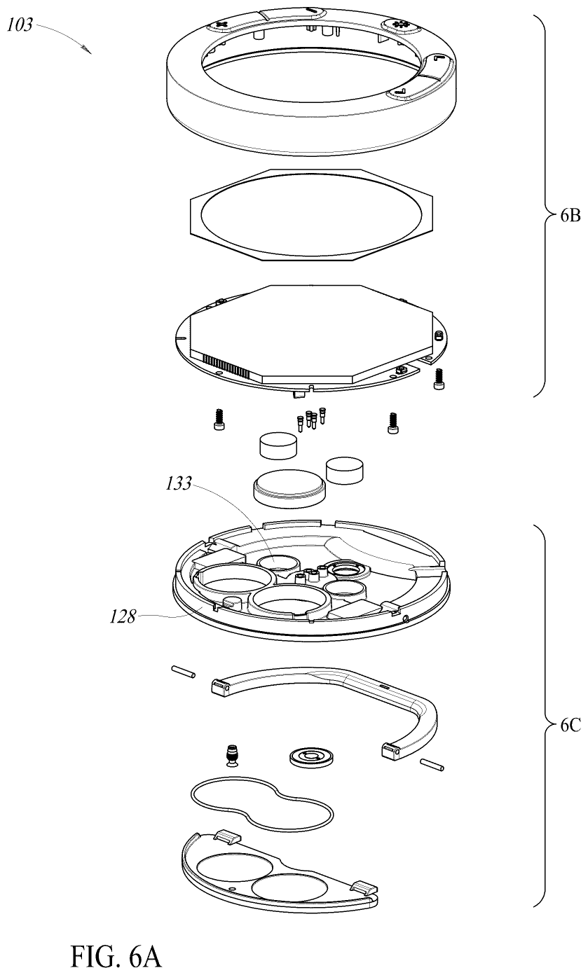

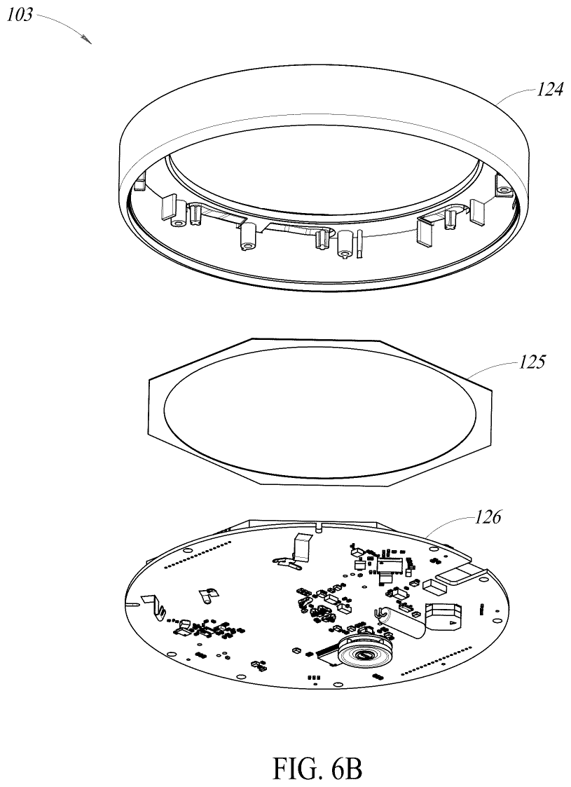

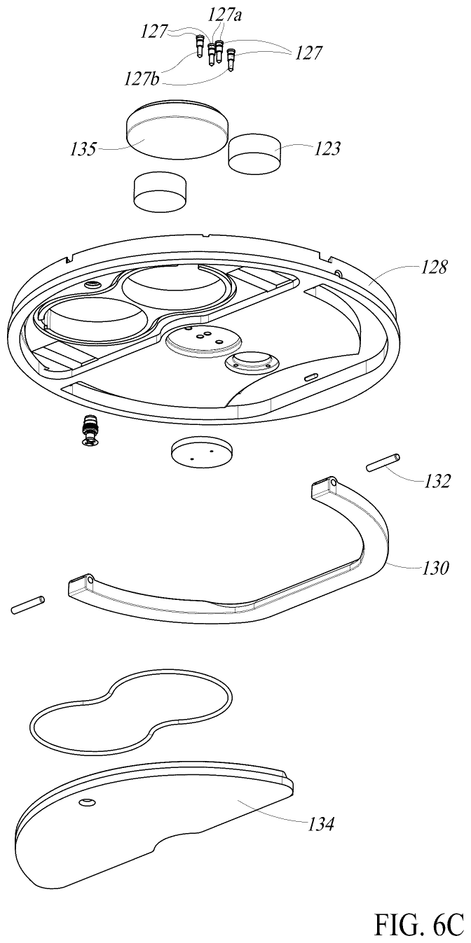

FIGS. 6A-6C are exploded views of the display 103. In particular, FIG. 6A is an exploded view of the entire display sub-assembly 103. FIG. 6B is a view of a top portion of the display 103 of FIG. 6A and FIG. 6C is a view of the bottom portion of the display 103 that each provide more detail of the components of the display 103. Referring to FIGS. 6A-65C, the display 103 includes an overmold or outer ring 124 that may be an outer housing for covering the internal electronics of the display 103. A gasket 125 is received inside the overmold or housing 124. A printed circuit board 126 (or PCB 126) is received inside the overmold 124 and carries hardware, circuits, and the like, for control and operation of the display 103. In some embodiments, the hardware coupled to the printed circuit board 126 is on a bottom surface of the board 126 with the top surface of the board 126 being covered in a protective layer or molding compound. The overmold 124 may be a ring that extends around, and covers, side surfaces and a portion of the top surface of the PCB 126 with the gasket 125 therebetween to assist with establishing a waterproof or hermetic seal between the overmold 124 and the PCB 126 and other internal electronics of the display 103. Thus, the gasket 125 assists with preventing intrusion of water or other contaminants from coming into contact with the internal control electronics of the display.

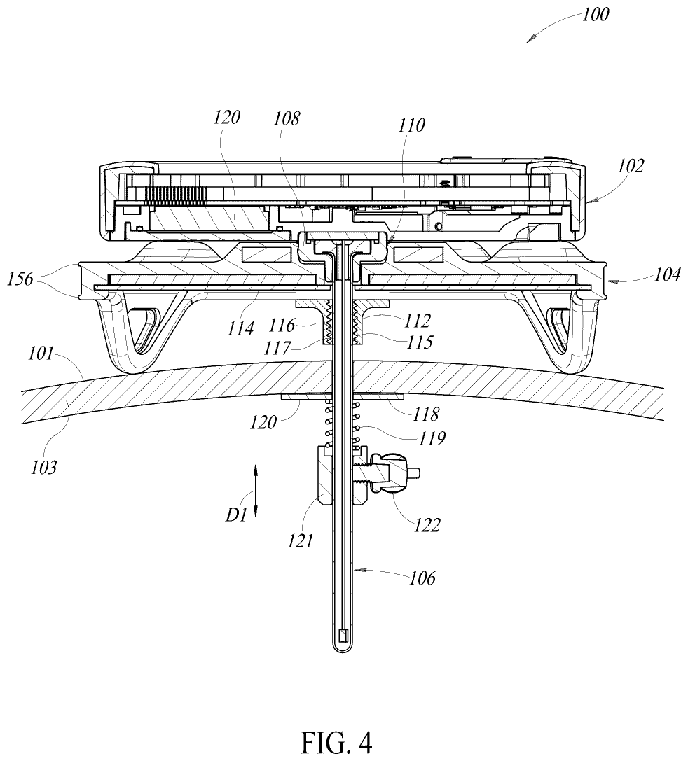

The display 103 further includes spring pins 127 and a rear cover 128. The spring pins 127 assist with establishing an electrical connection between the printed circuit board 126 and the temperature sensor 106 irrespective of the orientation of the display 103 to the heat shield 104. In other words, the display 103 can be magnetically coupled to the heat shield 104 in any orientation and the spring pins 127 maintain a reliable connection to the temperature sensor 106 for accurate temperature readings in any orientation of the display. In some embodiments, four spring pins 127 may be utilized to create an electrical connection between the printed circuit board 126 and the temperature sensor 106. For example, a first pair of spring pins 127a may contact a first ring of the printed circuit board 126, while a second pair of spring pins 127b may contact a second ring of the printed circuit board 126. Such a configuration may enable a reduction in resistance caused by way of connections of the spring pins 127a to the printed circuit board 126. The spring pings 127 be inserted through corresponding holes in the rear cover 128 to enable a direct electrical connection, as best shown in FIG. 4. A kickstand 130 is coupled to the rear cover 128 with pins 132 to enable rotation of the kickstand 130 relative to the rear cover 128. The magnets 123 are received in corresponding apertures or cavities 133 in the rear cover 128, as best shown in FIG. 6A. A battery door 134 is removably coupled to the rear cover 128, such as with fasteners. The battery door 134 provides access to a battery compartment of the display 103 to enable exchange of batteries 135 over time to power the display 103.

The removable display 103 magnetically attaches to the heat shield 104. The display 103 may optionally feature an LCD screen or other type of display, such as OLED, microLED, and others, such as on the top surface of the PCB 126. Optionally, the display screen may or may not be visible through a portion or all of the overmold 124. The display 103, and particularly, the PCB 126 also carry hardware that enables communication across various wireless communication protocols, including at least Wi-Fi and Bluetooth, and a user interface for temperature monitoring and control.

In more detail, the display 103 may be an electronic system or controller 103. The controller 103 is suitable for executing or otherwise performing at least some embodiments or techniques described herein with respect to the TMS 100. The physical or hardware aspects of the controller 103 may be located on or associated with the PCB 126 or otherwise internal to the overmold 124 of the controller 103 and communicatively coupled to at least the temperature sensor 106.

The controller 103 includes a processor, for example a microprocessor, digital signal processor, programmable gate array (PGA) or application specific integrated circuit (ASIC). The controller 103 includes one or more non-transitory storage mediums, for example read only memory (ROM), random access memory (RAM), Flash memory, or other physical computer- or processor-readable storage media in communication with the processor. The non-transitory storage mediums may store instructions and/or data used by the processor and the controller 103 generally. The instructions as executed by the processor may execute logic to perform the functionality of the various implementations or techniques of the devices and systems described herein, including, but not limited to, detecting temperature in an internal cavity of an appliance and wirelessly transmitting the temperature to an external device or network as well as enabling user control of various settings, and others.

The controller 103 may include one or more signaling devices or status indicators, such as a lighting element or light array and a speaker. The lighting element may be one or more light emitting diodes (LEDs) that emit light to provide a status indicator associated with operation of the TMS 100. For example, the lighting element may include at least one LED that illuminates when the TMS 100 is ON and is turned off to no longer emit light when the TMS 100 is OFF. The speaker may likewise provide audible feedback based on user input, such as to emit sound when a user changes a setting or presses a button on the interface of the TMS 100.

The control unit 103 may include a user interface to allow a user to operate or otherwise provide input to the TMS 100 regarding the operational state or condition of the TMS 100. The user interface may include a number of user actuatable controls accessible from the TMS 100. For example, the user interface may include a number of switches or keys operable to turn the TMS 100 ON and OFF and/or to set various operating parameters of the TMS 100, such as wireless connectivity modes, temperature adjustment, alarms when detected temperature is outside a predetermined range or threshold, and others. In some embodiments, the user interface includes at least switches or keys 136 in the overmold 124 that are electrically connected to the PCB 126 to allow a user to change operational characteristics of the TMS 100, as shown in FIG. 1.

In some embodiments, the user interface may include a display, as described, and may include a touch panel display. The touch panel display (e.g., LCD or LED with touch sensitive overlay) may provide both an input and an output interface for the user. The touch panel display may present a graphical user interface, with various user selectable icons, menus, check boxes, dialog boxes, and other components and elements selectable by the user to set operational states or conditions of the TMS 100. The user interface may also include one or more auditory transducers, for example one or more speakers and/or microphones. Such may allow audible alert notifications or signals to be provided to a user as a result of manual interaction with the user interface. Such may additionally, or alternatively, allow a user to provide audible commands or instructions. The user interface may include additional components and/or different components than those illustrated or described, and/or may omit some components. For example, in some embodiments, the display 103 includes only a display laminate without a touch sensitive overlay that displays information corresponding to the operational state or characteristics of the controller 103, as well as information associated with manual input from the user to the switches or keys 136. The display 103 may show information such as, but not limited to, a selected target temperature inside the appliance and an actual temperature inside the appliance, a timer, a change in target temperature based on input from the user, a symbol associated with a successful wireless connection (i.e., a wireless connection status symbol), and others.

The switches and keys or the graphical user interface may, for example, include toggle switches, a keypad or keyboard, rocker switches or other physical actuators of the type described herein. The switches and keys or the graphical user interface may, for example, allow an end user to turn ON or OFF the TMS 100, start or end a test or start-up mode, communicably couple or decouple to remote accessories, programs, and networks, change temperature thresholds and alert settings, and change a timer or turn ON or OFF a timer, and others.

The controller 103 includes a communications sub-system that may include one or more communications modules or components which facilitate communications with various components of one or more external devices, such as a personal computing device, mobile device, server, cloud computing device or network, among others. The communications sub-system may provide wireless or wired communications to the one or more external devices and may include wireless receivers, wireless transmitters and/or wireless transceivers to provide wireless signal paths to the various remote components or systems of the one or more paired devices. The communications sub-system may, for example, include components enabling short range (e.g., via Bluetooth®, BLE (“Bluetooth® low energy”), near field communication (NFC), or radio frequency identification (RFID) components and protocols) or longer range wireless communications (e.g., over a wireless LAN, Low-Power-Wide-Area Network (LPWAN), long range (LoRa), satellite, or cellular network) and may include one or more modems or one or more Ethernet or other types of communications cards or components for doing so. The communications sub-system may include one or more bridges or routers suitable to handle network traffic including switched packet type communications protocols (TCP/IP), Ethernet or other networking protocols.

The controller 103 further includes a power interface manager that manages supply of power from a power source to the various components of the controller 103 and the TMS 100. The power interface manager is coupled to the processor and the power source. Alternatively, in some implementations, the power interface manager can be integrated in the processor. The power source may include an external power supply, or a rechargeable or replaceable battery power supply, among others. The power interface manager may include power converters, rectifiers, buses, gates, circuitry, etc. in some embodiments. In particular, the power interface manager can control, limit, and/or restrict the supply of power from the power source based on the various operational states of the TMS 100.

In some embodiments, the power source may be configured to include a plurality of battery stages. For example, a first battery stage may comprise one or more coin batteries 135 and a second battery stage may comprise one or more rechargeable batteries (not shown). In some embodiments, the first battery stage may include two or more coin batteries 135. In some embodiments, the one or more coin batteries 135 may include a CR2450 battery. In some embodiments, the one or more rechargeable batteries include a lithium-ion battery. In some embodiments, the one or more rechargeable batteries may include a lithium-titanate battery. The second battery stage may be spaced apart from the high-temperature appliance by way of the first battery stage, such that the first battery stage is exposed to greater heat than the second battery stage. The one or more rechargeable batteries of the second battery stage may be recharged by way of current provided by the first battery stage. In such an embodiment, the one or more coin batteries 135 of the first battery stage may be held in the battery compartment to which the battery door 134 controls access, such that the one or more coin batteries 135 may be replaced. Such a configuration may enable the second battery stage to provide the required current to operate the controller 103 and TMS 100, while also reducing the risk of heat damage to the second battery stage.

In some embodiments or implementations, the instructions and/or data stored on the non-transitory storage mediums that may be used by the processor and the controller 103 generally, such as, for example, ROM, RAM, and Flash memory, includes or provides an application program interface (“API”) that provides programmatic access to one or more functions of the controller 103. For example, such an API may provide a programmatic interface to control one or more operational characteristics of the TMS 100, including, but not limited to, one or more functions of the user interface, processing and/or storing and/or transmitting the data received from the temperature sensor 106, and/or defining one or more signaling schemes for user alerts, among others. In this manner, the API may facilitate the development of third-party software, such as various different user interfaces and control systems for other devices, plug-ins, and adapters, and the like to facilitate interactivity and customization of the operation and devices within the TMS 100.

In some embodiments, components or modules of the controller 103 and other devices within the TMS 100 described herein are implemented using standard programming techniques. For example, the logic to perform the functionality of the various embodiments or techniques described herein may be implemented as a “native” executable running on the controller 103, e.g., microprocessor, along with one or more static or dynamic libraries. In other embodiments, various functions of the controller 103 may be implemented as instructions processed by a virtual machine that executes as one or more programs whose instructions are stored on ROM and/or RAM. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), or declarative (e.g., SQL, Prolog, and the like).

In a software or firmware implementation, instructions stored in a memory configure, when executed, one or more processors of the controller 103, such as microprocessor, to perform the functions of the controller 103. The instructions cause the microprocessor or some other processor, such as an I/O controller/processor, to process and act on information received from one or more sensors or other external devices to provide the functionality and techniques described herein.

The embodiments or implementations described above may also use well-known or other synchronous or asynchronous client-server computing techniques. However, the various components may be implemented using more monolithic programming techniques as well, for example, as an executable running on a single microprocessor, or alternatively decomposed using a variety of structuring techniques known in the art, including but not limited to, multiprogramming, multithreading, client-server, or peer-to-peer (e.g., Bluetooth®, NFC or RFID wireless technology, mesh networks, etc.), running on one or more computer systems each having one or more central processing units (CPUs) or other processors. Some embodiments may execute concurrently and asynchronously, and communicate using message passing techniques. Also, other functions could be implemented and/or performed by each component/module, and in different orders, and by different components/modules, yet still achieve the functions of the controller 103.

In addition, programming interfaces to the data stored on and functionality provided by the controller 103, can be available by standard mechanisms such as through C, C++, C#, and Java APIs; libraries for accessing files, databases, or other data repositories; scripting languages; or Web servers, FTP servers, or other types of servers providing access to stored data. The data stored and utilized by the controller 103 and overall TMS 100 may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible.

Furthermore, in some embodiments or implementations, some or all of the components of the controller 103 and components or other devices within the TMS 100 may be implemented or provided in other manners, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use, or provide the contents to perform, at least some of the described techniques.

A particular challenge with implementing wireless devices for measuring temperature inside of a cavity of an appliance is that the outer shell of the appliance, which may be metal, ceramic, or others, acts as a faraday cage or quasi-faraday cage that blocks transmission of wireless signals. Thus, it is preferable if the wireless receiver, transmitter, and/or wireless transceiver be located outside of the shell of the appliance. The TMS 100 described herein achieves transmission of temperature inside the cavity of the appliance by the temperature sensor 106 positioned inside the cavity and the display 103 mounted to the outer shell of the appliance. As described above, however, control electronics are not typically mounted on an outer shell of a high-temperature appliance because the heat transfer between the appliance and the control electronics can damage or impact the function of the electronics. The TMS 100 described herein overcomes this via the heat shield 104 described further below. In some embodiments, in addition to the above functions and advantages, the TMS 100 may be mechanically and/or communicatively coupled to a controller and/or temperature control device or controller of the appliance. The TMS 100 can therefore communicate with a temperature control device of the appliance, such as a fan, a feed system, air inlet or outlet, a vent controller, and/or solenoid valves associated with such air control or a gas or fuel source to manage temperature control. The fan may be configured to control airflow for combustion in an internal cavity of the appliance 102. The feed system may be configured to control a rate of combustion by controlling a flow rate of fuel into the internal cavity of the appliance 102. The vent controller may be configured to alter a vent to control a rate of combustion in the internal cavity of the appliance 102. The solenoid valves may be configured to control a rate of combustion by controlling a gas flow rate into the internal cavity of the appliance 102. In other words, in some embodiments, the TMS 100 may send instructions to a temperature control device of the appliance to change a characteristic of at least one of the above to automatically manage temperature within a selected or predetermined range or threshold set by the user on the TMS 100. For example, a user may select a set temperature by way of the display 103, which may then be input to the temperature control device by way of the TMS 100. In another example, a user may select a target temperature for an item within the appliance 102, and the target temperature may be provided to an external smart cooking device. For example, the external smart cooking device may be a device configured to determine a predictive cooking time calculation.

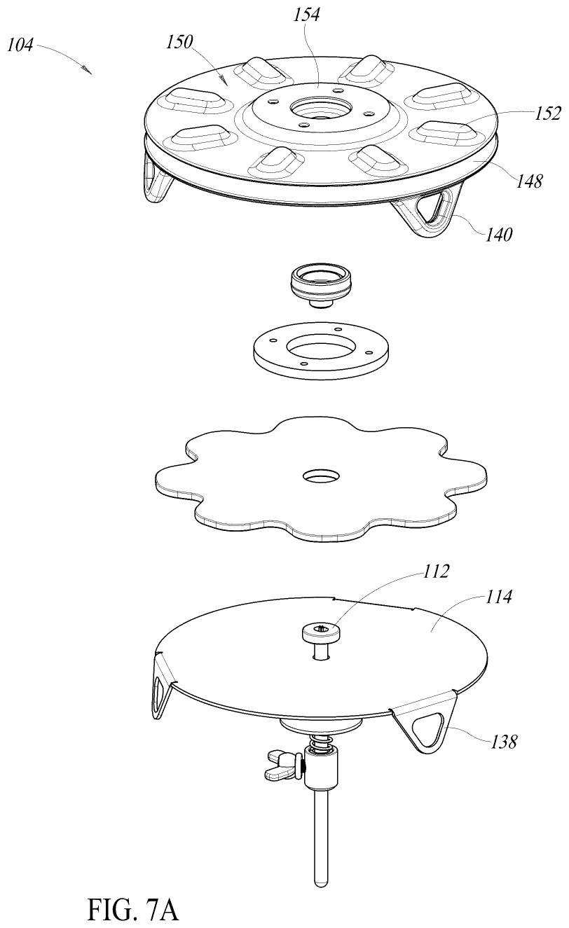

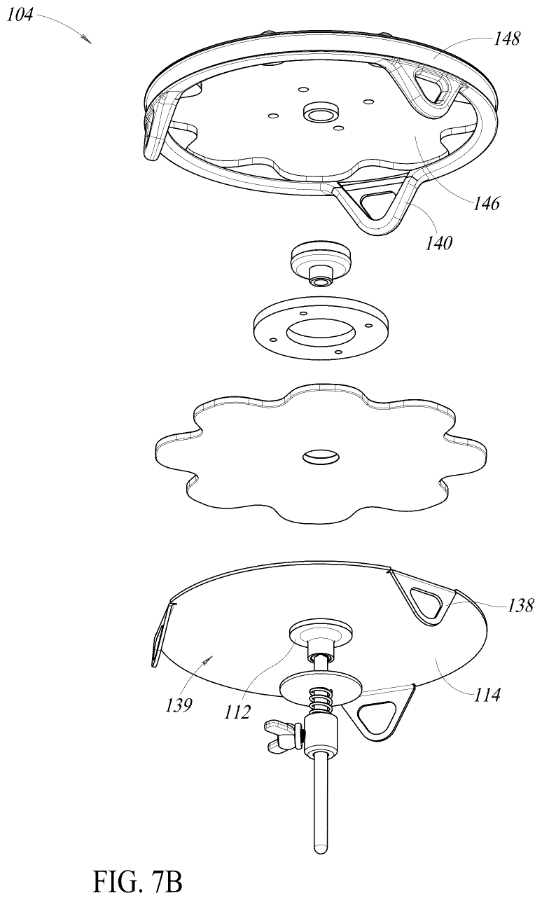

FIGS. 7A and 7B are top and bottom exploded views of the heat shield 104, respectively. The primary function of the heat shield 104 is to dramatically reduce heat transfer from the exterior of the high-temperature appliance to the electronics within the display 103 described above. With reference to FIGS. 7A and 7B, the heat shield 104 has a layered construction that begins at the bottom with the bottom plate 114. The bottom plate 114 may be a formed metal base featuring three equidistantly spaced legs 138. In some embodiments, a bottom surface 139 of the bottom plate 114 may be reflective to prevent or reject infrared radiation or radiated heat from the outer shell of the appliance from entering the heat shield 104. The bottom plate 114 may be formed of a rigid material capable of withstanding high temperatures. In some embodiments, the bottom plate 114 may be stainless steel. The equally spaced legs 138 create a tripod configuration that enables stable contact on various outer shells or lids of high-temperature appliances, including those with compound curves. It should be understood that heat shield 104 includes vertical sidewalls, but heat shield 104 may alternatively include a sloped sidewall or a sidewall of any other shape, such as curved. The legs 138 create an initial air gap of approximately 3-10 mm, or more or less, between the outer shell of the appliance and the bottom plate 114 of the heat shield 104. This air gap is best shown in FIG. 3 and provides a first thermal barrier. The equally spaced legs 138 may be formed by stamping and folding a portion of the bottom plate 114, such that the bottom plate 114 and the equally spaced legs 138 are a unitary body.

In some embodiments, the heat shield 104 further includes feet 140 that are received on the legs 138. The feet 140 may be high-temperature silicone or another material capable of withstanding high-temperature applications. The feet 140 are formed of a material with low thermal conductivity to prevent heat transfer from the outer shell of the appliance to the heat shield 104 and assist with enabling the first thermal barrier. The feet 140 may be in direct contact with the outer shell of the appliance and may have a high coefficient of friction to reduce or eliminate slippage or movement of the TMS 100 once coupled to the appliance in the manner described with reference to FIGS. 1-5.

Above the bottom plate 114 is a foil 142 that encases or houses a layer of thermal insulation 144. The bottom plate 114 may be configured to support the thermal insulation 144. In some embodiments, the thermal insulation 144 is optional, but preferred. The thermal insulation 144 is preferably likewise a material capable of withstanding high-temperature applications but with a low thermal conductivity. In some embodiments, the thermal insulation 144 is a disc of aerogel insulation. The aerogel layer ranges from 2.5 mm to 25 mm in thickness with a preferred range of 5-10 mm. The aerogel layer 144 significantly impedes conductive heat transfer and rejects heat due to its extremely low thermal conductivity. In some embodiments, the thermal insulation 144 has a maximum conductivity below 0.15 W/mK at 500 degrees C. In some embodiments, the thermal insulation 144 has a maximum conductivity below 0.05 W/mK at 500 degrees C. In some embodiments, the thermal insulation 144 has an operating limit above 400 degrees C. The thermal insulation 144 may be incombustible. The thermal insulation 144 may be configured to not outgas at high temperatures, such as 450 degrees C. Other types of insulation or insulative materials are also contemplated and could be substituted for the aerogel, particularly with different thickness or other characteristics. The thermal insulation 144 and the foil 142 provide a second thermal barrier.

Above the thermal insulation 144 is a metal top plate 146. The top plate 146 may be one or more pieces of ferritic metal to enable magnetic coupling with the display 103 via the magnets 123 described above. The entire sub-assembly is encapsulated in a high-temperature silicone cover 148. The silicone cover 148 may be supported by the bottom plate 114. A top surface 150 of the cover 148 features rotationally symmetric protrusions 152, which are preferably 2-5 mm in height. The protrusions 152 serve dual purposes or functions. First, the protrusions 152 further reduce heat transfer by minimizing the contact area with the display 103. Second, the protrusions 152 allow the display 103 to be oriented in any direction without regard to the installed orientation of the heat shield 104. In other words, when the display 103 is mounted or coupled to the heat shield 104 via the top plate 146, the bottom surface of the display 103 is in contact with the protrusions 152. The display 103 may also be in contact with a central raised ring 154 of the top plate 146 and/or heat shield 104. In particular, the magnets 123 may be positioned adjacent to or in close proximity to the central raised ring 154 to establish the magnetic connection between the magnets 123 and the raised ring 154. The protrusions 152 reduce contact surface area between the display 103 and the heat shield 104 relative to coupling the display 103 to a flat surface and also provide a further air gap between the display 103 and the heat shield 104 that acts as a third thermal barrier.

In some embodiments, and as best shown in FIG. 4, the cover 148 of the heat shield 104 also includes at least one, or more preferably two, outer ridges 156 extending outward and around the circumference of the cover 148. The ridges 156 help prevent the flow of hot air and heat from the first air gap between the heat shield 104 and the appliance from flowing around the heat shield 104 and into the second air gap between the protrusions 152 and the display 103. In other words, the ridges 156 assist with reducing or preventing heat transfer to the display 103 by elongating an air flow path and generally pushing hot air out and away from the heat shield 104 before it reaches the second air gap between the display 103 and the heat shield 104. The ridges 156 are preferably located at a top and bottom edge of the cover 148 of the heat shield 104, but may also be implemented with different configurations. For example, the ridges 156 may be one or more ridges at any location along the sidewall of the heat shield 104 and with any orientation (perpendicular, angled, parallel, etc.) to the sidewall of the heat shield 104. The ridges 156 may assist with providing the second thermal barrier associated with the heat shield 104.

The multi-layer configuration of the heat shield 104 enables significant rejection of heat, such as that described herein, that enables the use of the TMS 100 in high-temperature applications without damage or negative impact to the control electronics of the display 103. In some embodiments, the TMS 100 is designed to maintain a temperature differential of up to or exceeding 300 degrees Celsius (572 degrees F.) between the exterior surface of the appliance and the display 103, thus ensuring reliable operation in extreme temperature environments. In some embodiments, the TMS 100 is configured to maintain a temperature differential of up to 250 degrees C. between the outer shell 101 of the appliance 102 and the display 103 during operation. In some embodiments, the TMS 100 is configured to maintain a temperature differential of up to 300 degrees C. between the outer shell 101 of the appliance 102 and the display 103 during operation. In some embodiments, the TMS 100 is configured to maintain a temperature differential of up to 350 degrees C. between the outer shell 101 of the appliance 102 and the display 103 during operation. In some embodiments, the TMS 100 is configured to maintain a temperature differential of up to 400 degrees C. between the outer shell 101 of the appliance 102 and the display 103 during operation.

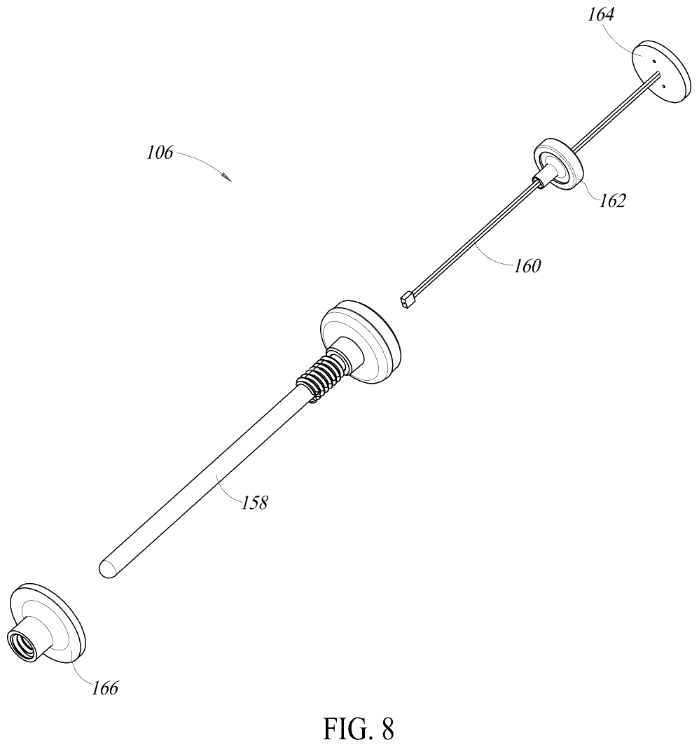

FIG. 8 is an exploded view of the temperature sensor 106. The sensor 106 includes a sensor tube 158, which penetrates the center of the heat shield 104. The tube 158 is preferably made of stainless steel for durability and low thermal conductivity and extends 20-100 mm into the interior cavity of the appliance. The tube 158 terminates at one end in a rounded or enclosed end and at another, opposite end in a ridge or flange that is received inside the plug 108 shown in FIG. 4. A temperature probe or sensor 160 is received inside the tube 158. The plug 108 may include a cap 162, a PCB 164 coupled or soldered to the probe 160, and a PCB housing 166 that receives and protects the cap 162 and the PCB 164. A top surface of the PCB 164 and control electronics mounted thereon are exposed by the housing 166 to enable an electrical connection between the temperature probe 160, the PCB 164, and the PCB 126 of the display 103, as described herein. Specifically, the PCB 164 may include two or more conductive rings that are electrically isolated from each other and correspond to the spring pins 127 described above to establish a secure electrical connection while maintaining thermal isolation to improve accuracy of readings from the temperature probe 160. Thus, in operation, heat from the internal cavity of the appliance is transmitted through the tube 158 and detected by the probe 160. The PCB 164 sends data and/or signals regarding the detected temperature to the display 103 for communication to the user, among other functions and techniques described herein.

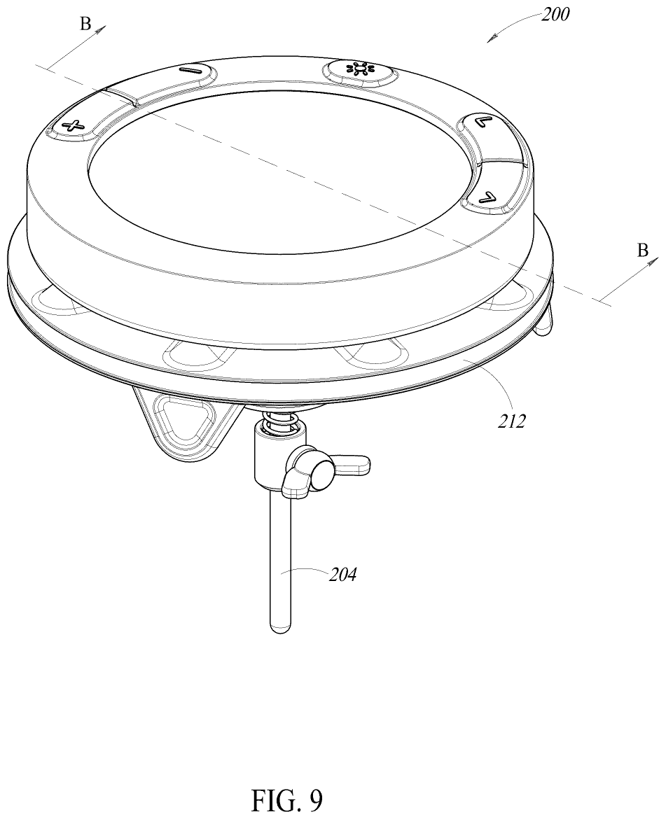

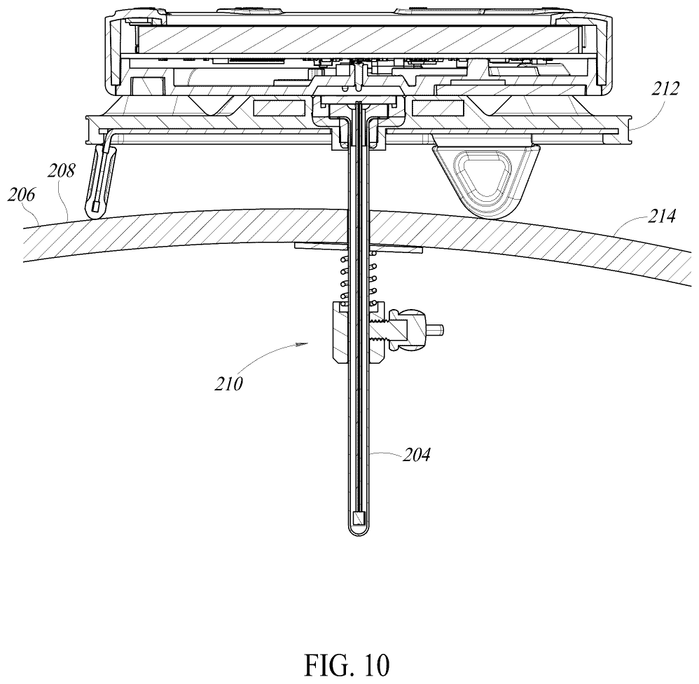

FIGS. 9 and 10 are views of an embodiment of a TMS 200 that may be similar to the TMS 100 except otherwise noted. In particular, FIGS. 9 and 10 are provided to illustrate that certain features of the TMS described herein may be adapted for different appliances. In particular, certain appliances may have a different size hole or opening for the TMS. It is generally less preferred for the user to drill their own, larger hole for the TMS or other temperature measurement device to avoid cracking or damaging the outer shell of the device. Thus, the TMS described herein may offer a variety of mounting options for versatility. For example, the TMS 100 described above includes a threaded standoff 116 to facilitate coupling.

Turning to FIGS. 9 and 10, a tube 202 that receives a temperature probe 204 therein may be 10-30 mm in diameter to fit different size openings in a shell 206 of an appliance 208, or enable a user to drill a relatively smaller hole in the shell 206 to enable use of the TMS 200. The tube 202 may include threads along at least a portion of a length thereof to eliminate the standoff 116 and weld nut 112 described with reference to TMS 100. As such, a fastening structure 210 inside the appliance 208 secures the TMS 200 thereto by tensioning the tube 202 and, thereby, compressing a heat shield 212 against the shell 206 or outer surface 214 of the appliance 208. The fastening structure 210 may include the washer 118, the spring 119, and the collar 121 as described with reference to TMS 100. Alternatively, the fastening structure 210 may include a wing nut configured to couple to the threads of the tube 202.

This coupling method distributes force for the coupling to the plug 216 of the temperature sensor 204. FIGS. 9 and 10 also show that the heat shield 212 may have a generally lower thickness in some embodiments depending on the amount of desired heat rejection and materials used in construction of the TMS.

In the above description, certain specific details are set forth in order to provide a thorough understanding of various embodiments of the disclosure. However, one skilled in the art will understand that the disclosure may be practiced without these specific details. In other instances, well-known structures associated with detection systems, devices, and methods have not been described in detail to avoid unnecessarily obscuring the descriptions of the embodiments of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a die may refer to one die. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other derivatives thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Generally, unless otherwise indicated, the materials for making the invention and/or its components may be selected from appropriate materials such as composite materials, ceramics, plastics, metal, polymers, silicone, thermoplastics, elastomers, plastic compounds, and the like and may include one or more additives.

The foregoing description, for purposes of explanation, uses specific nomenclature and formula to provide a thorough understanding of the disclosed embodiments. It should be apparent to those of skill in the art that the specific details are not required in order to practice the invention. The embodiments have been chosen and described to best explain the principles of the disclosed embodiments and its practical application, thereby enabling others of skill in the art to utilize the disclosed embodiments, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “left,” “right,” and other like derivatives are used only for discussion purposes based on the orientation of the components in the Figures of the present disclosure. These terms are not limiting with respect to the possible orientations explicitly disclosed, implicitly disclosed, or inherently disclosed in the present disclosure and unless the context clearly dictates otherwise, any of the aspects of the embodiments of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various embodiments described herein, and as such, it is expressly contemplated in the present disclosure to include dimensions that are more or less than the dimensions stated, unless the context clearly dictates otherwise.

The various embodiments described above can be combined to provide further embodiments. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

This application claims the benefit of priority to U.S. Provisional Application No. 63/677,291, filed Jul. 30, 2024, the contents of which are hereby incorporated by reference in their entirety.

1. A temperature measurement system, comprising:
a heat shield assembly, including:
a base including at least three support legs;
a thermal insulation layer disposed on the base; and
at least one magnetic element; and
a cover, the cover including a plurality of protrusions;
a display removably and magnetically coupleable to the heat shield assembly;
a temperature probe extending through the heat shield and configured to detect temperature in an internal cavity of an appliance; and
a mounting assembly configured to couple the heat shield to an outer shell of the appliance.

2. The temperature measurement system of claim 1, wherein the display includes a controller configured to communicate wirelessly via at least one of Wi-Fi, long range (LoRa), Bluetooth Low Energy (BLE), or another radio communication protocol.

3. The temperature measurement system of claim 1, wherein the mounting assembly includes a tube, the tube configured to attach to a threaded boss on a bottom surface of the heat shield assembly.

4. The temperature measurement system of claim 1, wherein the temperature probe includes a tube configured to extend into the internal cavity of the appliance.

5. The temperature measurement system of claim 1, wherein the thermal insulation layer includes an operating limit above 400 degrees C.

6. The temperature measurement system of claim 1, wherein the thermal insulation layer includes a maximum conductivity below 0.15 W/mK at 500 degrees C.

7. The temperature measurement system of claim 1, wherein the thermal insulation layer is on an end of the heat shield assembly opposing the display.

8. A heat shield for a temperature measurement device, comprising:
a base including three or more legs, the three or more legs spaced equidistant from each other and configured to create an air gap between the base and an appliance to which the base is configured to be coupled;
an insulation layer on the base;
one or more magnetic elements;
a silicone cover encapsulating the base, the insulation layer, and the one or more magnetic elements; and
a central aperture in the base and the insulation layer, the central aperture configured to receive a temperature sensor probe.

9. The heat shield of claim 8, wherein the silicone cover includes at least three rotationally symmetric protrusions configured to contact an external device that is configured to be coupled to the silicone cover.

10. The heat shield of claim 9, wherein the external device is a display configured to be magnetically coupled to the silicone cover.

11. The heat shield of claim 8, further comprising:
a sensor interface disc having at least two electrically isolated concentric conductive rings configured to electrically connect to an external device.

12. The heat shield of claim 8, wherein the legs and the base are a unitary body, and
wherein the base is a rigid material capable of withstanding a temperature of 450 degrees C.

13. The heat shield of claim 12, wherein the base and the legs comprise stainless steel.

14. The heat shield of claim 8, wherein a bottom surface of the base includes a threaded attachment point configured to couple the base to the appliance.

15. A method of measuring and displaying temperature of an internal cavity of an appliance, comprising:
mounting a multi-layered heat shield to an external surface of the appliance using an adjustable threaded assembly;
inserting a temperature sensor through the heat shield into the internal cavity of the appliance;
magnetically attaching a display to the heat shield, including establishing an electrical connection between the temperature sensor and the display via spring-loaded pins and concentric and thermally isolated conductive rings; and
wirelessly transmitting temperature data from the display.

16. The method of claim 15, further comprising:
inputting a target temperature to the display; and
transmitting the target temperature to an external smart cooking device configured to control a temperature of the internal cavity of the appliance.

17. The method of claim 15, further comprising:
rotating the display to a selected orientation on the heat shield without affecting temperature measurement by the temperature sensor.

18. The method of claim 15, further comprising:
inputting a set temperature to the display; and
communicating the set temperature from the display to a combustion device configured to adjust a temperature in the internal cavity of the appliance.

19. The method of claim 15, wherein wirelessly transmitting temperature data from the display includes the display receiving power from a multi-stage battery, the multi-stage battery including a first battery stage configured to recharge a second battery stage of the multi-stage battery,
wherein the second battery stage is spaced apart from the appliance such that the first battery stage is closer to the appliance than the second battery stage.

20. A temperature measurement system configured to be mounted to an appliance, comprising:
a multi-layered heat shield assembly;
a display removably coupled to the multi-layered heat shield assembly; and
a temperature sensor extending through the multi-layered heat shield assembly,
wherein the multi-layered heat shield assembly is configured to maintain a temperature differential of up to 250 degrees C. between an outer shell of the appliance and the display during operation.
